(19) United States
(12) Patent Application Publication
(10) Pub. No.: US 2023/0104389 A1
(43) Pub. Date: Apr. 6, 2023

(54) ELASTIC MEMBER FOR PUMP DISPENSER

(71) Applicants: Sunsoo Kim, Yongin-si (KR); Man Gyu Jung, Cheonan-si (KR)

(72) Inventors: Sunsoo Kim, Yongin-si (KR); Man Gyu Jung, Cheonan-si (KR)

(21) Appl. No.: 17/848,620

(22) Filed: Jun. 24, 2022

(30) Foreign Application Priority Data
Oct. 5, 2021 (KR) 20-2021-0003004

(51) Int. Cl. B05B 11/00; F16F 1/373

(52) U.S. Cl. CPC B05B 11/3077; F16F 1/373

(57) ABSTRACT

An elastic member made of a non-metal material, which is used for a pump dispenser, according to some embodiments of the present disclosure may include: an upper ring; a lower ring; and a plurality of links, which is laminated and connected in a zig-zag form to provide elastic restoration force for compression or elongation.

### RELATED APPLICATIONS

This application claims priority under the Paris Convention to KR Application No. 20-2021-0003004, filed Oct. 5, 2021. This application is herein incorporated by reference, in its entirety, for all purposes.

### FIELD OF THE DISCLOSURE

The present disclosure relates to an elastic member for pump dispenser, more particularly, to an elastic member made of non-metal material that is mounted inside a pump dispenser to provide uniform elastic restoration, which is substantially the same as a function of the existing metal spring.

### BACKGROUND

Generally, a pump dispenser refers to a device that discharges a certain amount of gas, liquid or other content filled in an airtight container by pressurization in order to use the same, and is applied to different airtight containers for storage of cosmetics, perfumes, medicines or foods.

When a user applied external force to a pump dispenser, the content inside a container coupled with the pump dispenser may be discharged to the outside. Meanwhile, the pump dispenser is provided with a spring and, when the external force applied by the user is released, the deformed pump dispenser may be restored to its original state.

Herein, the above spring is formed of a metal material. Therefore, if intended to recycle the pump, it is further required to separate the spring made of a metal material, which is provided inside the pump. However, due to a complicated structure of the pump, there is a problem in that it is difficult to separate the metal spring present inside the pump by the user.

### SUMMARY

### Technical Problem

The present disclosure has been proposed in response to the above described background art, and is intended to provide an elastic member formed of a non-metal material, which has elastic restoration force, instead of a spring made of a metal material.

Technical problems in the present disclosure are not limited to the above mentioned technical problem, and other technical problems not mentioned herein will be obviously appreciated from the description later by persons having ordinary knowledge in the art to which the present disclosure pertains (“those skilled in the art”).

### Technical Solution

With regard to the elastic member made of a non-metal material used for a pump dispenser in order to solve the above problems, the elastic member may include: an upper ring; a lower ring; and a plurality of links, which are laminated and connected in a zig-zag form between the upper ring and the lower ring so as to provide elastic restoration force for compression or elongation.

Alternatively, two adjacent links among the plurality of links may be connected at ends thereof such that these are inclined to each other, wherein consecutive links may be alternately connected at one side or the other side in a width direction of the elastic member.

Alternatively, a first reinforcing unit that reinforces the elastic restoration force while coupling the two adjacent links on a connection part, at which the two adjacent links among the plurality of links are connected together, may further be included.

Alternatively, a second reinforcing unit that reinforces the elastic restoration force while coupling the upper ring and the first link connected to the upper ring among the plurality of links; and a third reinforcing unit that reinforces the elastic restoration force while coupling the lower ring and the second link connected to the lower ring among the plurality of links, may further be included.

Alternatively, each of the upper ring, the lower ring and the plurality of links may have a center hole through which at least a portion of a stem in the pump dispenser passes.

Alternatively, the non-metal material may be any one among plastic, rubber and thermoplastic elastomer materials.

Effects of Device

The elastic member for pump dispenser according to the present disclosure is formed of a non-metal material having elastic restoration force instead of a metal material, therefore, can be recycled without further separation of the pump dispenser.

Effects possibly attained by the present disclosure are not limited to the effects described above, other effects not specified herein will be obviously anticipated from the description later by those skilled in the art.

Various embodiments will be hereinafter described with reference to the drawings, wherein similar reference numerals are generally used to define similar components. In the following examples, for purpose of explanation, a number of specific details will be proposed to provide overall understanding of one or more embodiments. However, it will be obviously understood that such embodiment(s) can be implemented without the above specific details.

### BRIEF DESCRIPTION OF THE DRAWINGS

FIG. 1 is a perspective view of an elastic member for pump dispenser according to some embodiments of the present disclosure.

FIG. 2 is a perspective view illustrating one example of the pump dispenser to which the elastic member according to some embodiments of the present disclosure is used.

FIG. 3 is a cross-sectional view taken along line A-A′ shown in FIG. 2.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

Various embodiments and/or aspects are now described with reference to the drawings. In the following description, for purpose of explanation, a number of specific details will be set forth in order to support overall understanding of one or more aspects. However, it will also be appreciated by those skilled in the art that such aspect(s) may be practiced without the specific details described above. The following description and accompanying drawings concretely stipulate illustrative embodiments of one or more aspects. It is to be understood, however, that such embodiments are illustrative only and that some of diverse ways in the principle of various embodiments may be used, and that the description is intended to include all such embodiments and their equivalents. Specifically, an “embodiment”, “example”, “aspect”, “illustrative”, etc. as used herein may not be construed that any embodiment or design described herein is better or more advantageous than other embodiments or designs.

Hereinafter, the same or similar components are assigned with the same reference numbers regardless of the reference numerals in the drawings, and overlapping descriptions will be omitted. Further, in describing the embodiments disclosed in the present specification, detailed descriptions of related well-known technologies are omitted when it is determined to obscure the gist of the embodiments disclosed herein. Further, the accompanying drawings are only for easy understanding of the embodiments disclosed in the present specification, and the technical spirit disclosed herein is not limited by the accompanying drawings.

Although the “first”, “second”, etc. are used to specify various devices or components, it is a matter of course that these devices or components are not limited by these terms. These terms are only used to distinguish one element or component from another element or component. Therefore, it is of course that the first element or component mentioned below may be the second element or component within the technical spirit of the present invention.

Unless otherwise defined, all terms (including technical and scientific terms) used in the present specification may be used as meanings that can be commonly understood by those skilled in the art to which this disclosure pertains. Further, terms defined in the commonly used dictionary are not ideally or excessively interpreted unless specifically defined.

Further, the term “or” is intended to mean an inclusive “or” rather than an exclusive “or”. In particular, unless specified otherwise or if it is unclear in context, the phrase “X uses A or B” is intended to mean one of the natural inclusive substitutions. That is, if X uses A; X uses B; or X uses both A and B, the expression of “X uses A or B” can be applied to either of the above cases. Further, it should also be understood that the term “and/or” as used herein refers to and includes all possible combinations of one or more of the listed related items.

Further, the term “includes (comprises)” and/or “including (comprising)” mean that the corresponding feature and/or component is present, but it should also be understood that the presence or addition of one or more other features, components and/or groups thereof is not excluded. Further, unless specified otherwise or if it is unclear in the context as indicating a singular form, the singular form in the specification and claims should generally be construed to mean “one or more”.

It is to be understood that, when an element is referred to as being “bound” or “connected” to another element, the former may be directly bound or connected to the latter, but may also be bound or connected to the latter while interposing a different element therebetween. On the other hand, when an element is referred to as being “directly bound” or “directly connected” to another element, it should be understood that there are not other elements therebetween.

The suffixes “module” and “part (or unit)” for components used in the following description are given or mixed only considering the convenience of writing the specification, and do not have meanings or roles that are distinguished themselves from each other.

It is to be understood that, when an element or layer is referred to as being “above” or “on” of another element or layer, this includes all cases where a component or layer is present next above or directly on another component or layer and where a different layer or component is interposed therebetween. On the other hand, when a component is referred to as being “directly on” or “next above” another component, this indicates that no other component or layer is interposed therebetween.

The spatially relative terms such as “below”, “beneath”, “lower”, “above”, “upper”, etc. may be used to easily describe a component or a relationship of the component to other components as illustrated in the drawings. Such spatially relative terms should be understood to include, in addition to the orientation shown in the drawings, terms that include different orientations of the component during use or operation.

For example, when inverting a component shown in the figures, the component described as being “below” or “beneath” of another component may be placed “above” another component. Thus, the exemplary term “below” may include both of downward and upward directions. The component may also be oriented in different directions so that spatially relative terms can be interpreted according to orientation.

The objects and effects of the present disclosure, and technical configurations for achieving the same will be clarified with reference to embodiments described below in detail along with the accompanying drawings. In describing the present disclosure, if it is determined that a description of known functions or configurations may unnecessarily obscure the gist of the present disclosure, a detailed description thereof will be omitted. Further, terms to be described later are terms defined in consideration of functions in the present disclosure and may vary according to the intention or custom of users or operators.

However, the present disclosure is not limited to the embodiments disclosed below, and may be implemented in various different forms. The present embodiments are provided only to make the present disclosure complete, and to fully disclosure the scope of the disclosure to those skilled in the art to which this disclosure pertains, and the present disclosure is only defined by the scope of the claims. Therefore, the definition should be made based on the contents throughout the present specification.

Using an elastic member made of a non-metal material (“non-metal elastic member”) instead of a metal spring in a pump dispenser is preferable in an aspect of recycling. However, the non-metal elastic member may entail a difficulty in sufficiently providing elastic restoration force. Further, the non-metal elastic member sufficiently providing elastic restoration force may be deformable only when a strong external force is applied thereto because the elastic restoration force is too strong. In this case, it may involve a problem in that a pump dispenser must be strongly pushed by a user of the pump dispenser to activate (or operate) the pump dispenser so as to discharge the content of the pump dispenser to the outside. In order to solve the above problem, it is required that the non-metal elastic member should have a specific structure. Hereinafter, the above configuration will be described in detail.

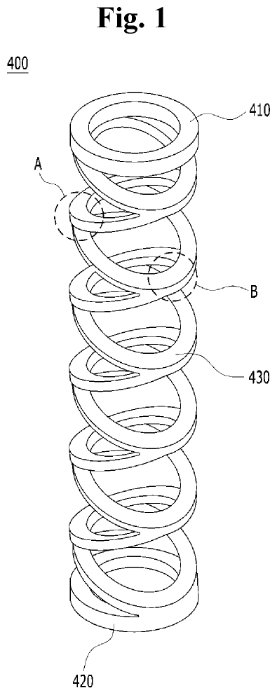

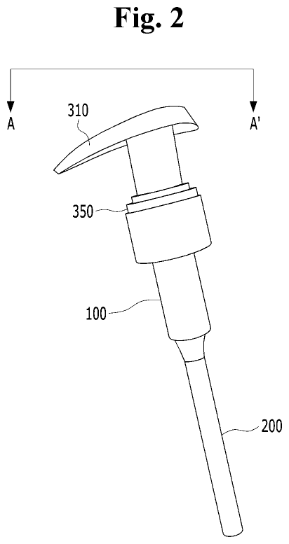

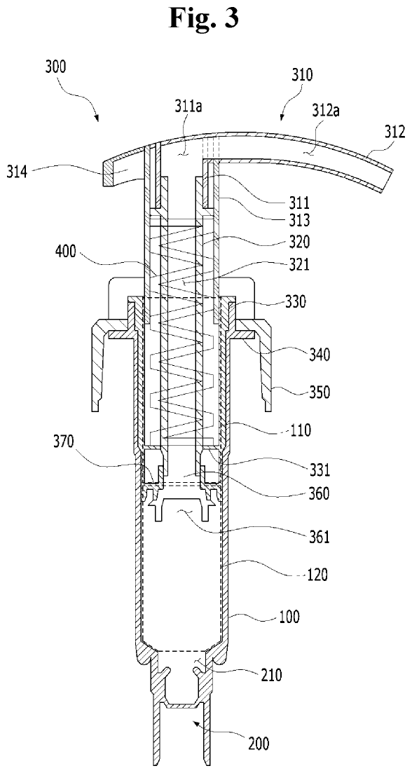

FIG. 1 is a perspective view of an elastic member for pump dispenser according to some embodiments of the present invention. FIG. 2 is a perspective view illustrating one example of the pump dispenser to which the elastic member according to some embodiments of the present disclosure is used. FIG. 3 is a cross-sectional view taken along line A-A′ shown in FIG. 2.

FIG. 2 and FIG. 3 illustrate one example of the pump dispenser in which the elastic member shown in FIG. 1 is used. Therefore, the elastic member shown in FIG. 1 may be used in the pump dispenser shown in FIGS. 2 and 3, however, may also be used in different pump dispensers other than the pump dispenser shown in FIGS. 2 and 3. Moreover, the elastic member shown in FIG. 1 may be disposed on a site different from that shown in FIGS. 2 and 3.

The elastic member 400 of the present disclosure may be used in a pump dispenser. In this regard, the pump dispenser is a device that discharges a predetermined amount of gas, liquid or other contents filled in an airtight container by pressurization, and may mean to be applied to a variety of airtight containers to store cosmetics, perfumes, medicines and foods, but is not particularly limited thereto.

The elastic member 400 may be formed using a non-metal material having elastic restoration force for compression or elongation. In this regard, the elastic member 400 may be formed using any one material among plastic, rubber or thermoplastic elastomer materials.

The plastic material may include at least one among polypropylene (PP), polyethylene (PE), ethylene-vinyl acetate copolymer (EVA), polyvinyl chloride (PVC) and polyurethane (PU), but is not particularly limited thereto.

The rubber material is a chemically cross-linked polymer and may include any one among natural rubber and synthetic rubber. In this regard, the synthetic rubber may include styrene-butadiene rubber, but is not particularly limited thereto.

The thermoplastic elastomer material may be a polymer material, which is formable like plastics being flexible at a high temperature and exhibits properties of elastomer at room temperature. Accordingly, the elastic member 400 may have a restoration force using thermoplastic elastomer that exhibits properties of a rubber elastic substance at room temperature. Specifically, the thermoplastic elastomer is a polymer material which shows rubber elastic property under use conditions while being formable like a thermoplastic (plastic) substance under certain forming conditions, but is not particularly limited thereto.

The thermoplastic elastomer may be classified into: styrene-based elastomer (thermoplastic styrene block copolymer; SBC); olefin-based elastomer (thermoplastic olefinic elastomer; TPO); urethane-based elastomer (thermoplastic polyurethane; TPU); amide-based elastomer (thermoplastic polyamide; TPAE); polyester-based elastomer (thermoplastic polyester elastomer; TPEE), etc. based on materials to be used, however, is not particularly limited thereto.

According to some embodiments of the present disclosure, the elastic member 400 based on a polypropylene material (PP) may provide most desirable elastic restoration force. Specifically, PP-based elastic member 400 acts a pump dispenser easier than other elastic members made of other materials having the same shape and morphology, and may provide sufficient elastic restoration force.

Referring to FIG. 1, the elastic member 400 may include an upper ring 410, a lower ring 410 and a plurality of links 430. However, these components are not essential for implementing the elastic member 400, instead, the elastic member 400 may be provided with a larger or smaller number of components than the above-mentioned components.

The upper ring 410 may refer to a ring type plate formed on an upper portion of the elastic member 400. The lower ring 420 may refer to a ring type plate formed on a lower portion of the elastic member 400.

According to some embodiments of the present disclosure, the upper ring 410 and the lower ring 420 may have each center hole through which a center portion of a stem (320 in FIG. 3) passes. A size and shape of an inner periphery (a size and shape of the center hole) of each of the upper ring 410 and the lower ring 420 may correspond to a size and shape of an outer periphery of the center portion of the stem (320 in FIG. 3). Therefore, the center portion of the stem 320 may pass through the center hole of each of the upper ring 410 and the lower ring 420.

The upper ring 410 may be arranged below a force transfer member protruding outward from an upper part of the center portion of the stem 320 along an outer periphery thereof. Further, the lower ring 420 may be seated on a seating member 331 protruding inward from a lower part of a chaplet 330. Herein, the seating member 331 may be a component not being influenced and not moving by an external force even when the external force is applied to the pump dispenser. Therefore, if the stem 320 descends by the external force, the external force may be transferred to the upper ring 410 which in turn moves the upper ring 410 downward, however, the lower ring 420 may not move downward.

Meanwhile, since the lower ring 420 does not move downward when the upper ring 410 moves downward, the plurality of links may be deformed. At this time, the plurality of links 430 may have a tendency of returning to the original shape by the elastic restoration force. Therefore, the plurality of links 430 may push the upper ring 410 upward if the external force applied to the pump dispenser is released. When the plurality of links 430 has pushed the upper ring 410 upward, a force may be transferred to the force transfer member of the stem (320 in FIG. 3). In this case, the pump dispenser may return to the status before application of the external force to the pump dispenser.

The plurality of links 430 may refer to a plurality of plates in a ring shape between the upper ring 410 and the lower ring 420, which has a structure to provide elastic restoration force for compression or elongation while connecting the upper ring 410 and the lower ring 420.

Each of the plurality of links 430 has a ring type plate to thus include a center hole. In this regard, the center portion of the stem (320 in FIG. 3) of the pump dispenser may pass through the center hole, but is not limited thereto. Alternatively, other components of the pump dispenser may pass through the center hole.

The size and shape of an inner periphery of each link 430 (the size and shape of the center hole) may correspond to the size and shape of an outer periphery of the center portion of the stem 320. Therefore, the center portion of the stem 320 may pass through the center holes of the upper ring 410 and the lower ring 420.

When the stem passes through the center hole provided in each of the upper ring 410, lower ring 4120 and plurality of links 430, the upper ring 410, the lower ring 420 and the plurality of links 430 may provide elastic restoration force to the pump dispenser while being fixed inside the pump dispenser by the stem 320.

The plurality of links 430 may be laminated and connected in a zig-zag form between the upper ring 410 and the lower ring 420. Therefore, the plurality of links 430 may provide the elastic restoration force for compression and elongation.

Specifically, two adjacent links among the plurality of links 430 are connected at the ends thereof to be inclined to each other, wherein the consecutive links can be connected alternately at one side A and the other side B in a width direction of the elastic member 400. Accordingly, a space is formed between the consecutive links and enables compression by an external force to be smoothly performed. That is, such a linkage structure of the plurality of links may induce elastic restoration force not too strong.

Meanwhile, a first reinforcing unit may be provided on a portion at which two adjacent links among the plurality of links 430 are connected. The first reinforcing unit may reinforce the elastic restoration force while providing a function of coupling the two adjacent links.

Specifically, the plurality of links 430 are coupled to one another, wherein the same material as the plurality of links 430 may be used for reinforcing at each coupling position of the plurality of links 430. At this time, the reinforced portion may become the first reinforcing unit. Therefore, a portion at which the plurality of links 430 are connected to each other may become thicker than other portions owing to the first reinforcing unit.

For example, two adjacent links among the plurality of links 430 may be coupled at the ends thereof through the first reinforcing unit so as to be inclined to each other. Further, the consecutive links may be connected alternately at one side A and the other side B in a width direction of the elastic member 400 through the first reinforcing unit.

Even with a structure for simply coupling the plurality of links 430, elastic restoration force may occur. In this case, the elastic restoration force may include a force insufficient to return the pump dispenser to its original state when an external force applied to the pump dispenser is removed. However, as in the present disclosure, in the case where a first reinforcing unit is further provided on a portion at which two adjacent links among a plurality of links 430 are connected, the elastic restoration force may further be increased. In this case, when the external force applied to the pump dispenser is removed, the elastic restoration force may include a force sufficient to return the pump dispenser to its original state.

Meanwhile, a first link connected to the upper ring 410 among the plurality of links 430 may be coupled to the upper ring 410 through a second reinforcing unit. Further, a second link connected to the lower ring 420 among the plurality of links may be coupled to the lower ring 420 through a third reinforcing unit. Therefore, the elastic restoration force of the elastic member 400 may further be increased.

Further, when the upper ring 410 and the lower ring 420 are each formed of a non-metal material having elastic restoration force, a pressure applied to the elastic member 400 may be partially absorbed in the upper ring 410 and the lower ring 420. Therefore, it is possible to prevent the configuration of the elastic member 400 (for example, the upper ring 410, the lower ring 420 and the plurality of links 430) from being destroyed or cracked by excessive external pressure.

Further, the plurality of links 430 may have a thru-hole formed to pass at least a part of the stem 320, and the plurality of links 430 may have the same shape or size. Accordingly, the plurality of links 430 may be connected to one another while having a predetermined angle. That is, the plurality of links 430 may be compressed more smoothly as compared to an elastic member that has a structure with different angles at connected sites due to different shapes and sizes, thereby having higher elastic restoration force.

Meanwhile, when the elastic member 400 has the structure illustrated in FIG. 1, it is possible to prevent a discharge unit (300 in FIG. 3) from rotating when the stem descends by an external force. Therefore, a user may more conveniently use the pump dispenser. Further, in order to ensure desirable elastic restoration force, the elastic member 400 may be prepared with a long length. However, since the elastic member 400 cannot have infinite length, the structure illustrated in FIG. 1 may be the best one to properly provide the elastic restoration force while ensuring desired stroke.

Further, when the elastic member 400 has the structure illustrated in FIG. 1, distortion may be prevented to thus provide more stable and uniform elastic restoration force when operating the pump dispenser.

Referring to FIGS. 2 and 3, the pump dispenser may include a housing 100, a transfer unit 200, a discharge unit 300 and an elastic member 400. However, the above components are not essential for implementing the pump dispenser, instead, the pump dispenser may be provided with a larger or smaller number of components than the above-mentioned components.

In the present disclosure, the pump dispenser may be connected to a container. Herein, the container connected with the pump dispenser may be in a cylindrical form having a predetermined depth in order to receive content in liquid state, and may be formed to have open top and closed bottom but is not particularly limited thereto.

Meanwhile, the housing 100 may be clamped with the transfer unit 200 and coupled with the discharge unit 300. Specifically, the transfer unit 200 may be clamped on a lower portion of the housing 100 while the discharge unit 300 may be coupled to an upper portion of the housing 100.

Further, the housing 100 may be formed to have a vacant space therein. Specifically, the housing 100 may be formed in a cylindrical shape, which has open top and bottom surfaces and is hollow inside. Further, the housing 100 may be provided with at least a part of the elastic member 400.

Further, the housing 100 may include a first space 110 and a second space 120 therein. Herein, the first space 110 may be provided on the upper portion of the housing 100 while the second space 120 may be provided on the lower portion of the housing 100. However, the above components are not essential for implementing the housing 100, instead, the housing 100 may be provided with a larger or smaller number of components than the above-mentioned components.

The first space 110 may be a space to which the content of the container is not transferred. That is, the first space 110 is a space separated from the second space 120 by a piston 370 and a sub-stem 360 of the discharge unit 300 described later, wherein the content transferred from the container to the second space 120 may not be transferred to the first space.

The second space 120 may be a space to which the content of the container is transferred. Herein, the content may be transferred to the second space 120 through the transfer unit 200.

Meanwhile, the housing 100 may be formed using a plastic material. For example, the housing 100 may be made of at least one among high-density polyethylene (HDPE), polyvinyl chloride (PVC), polypropylene (PP), polyethylene (PE), acrylonitrile butadiene styrene copolymer (ABS), polycarbonate-acrylonitrile butadiene styrene copolymer (PC-ABS) and ethylene-vinyl acetate copolymer (EVA), but is not particularly limited thereto.

The transfer unit 200 may be clamped and arranged on the lower portion of the housing 100. Specifically, an upper portion of the transfer unit 200 may be clamped on the lower portion of the housing 100. At this time, the transfer unit 200 may have a second seating groove 210 formed on top thereof.

Meanwhile, a dip tube (not shown) may be clamped on the transfer unit 200. Further, the dip tube (not shown) may transfer the content received in the container to the inside of the housing 100 (for example, the second space 120) through the transfer unit 200. Specifically, the dip tube (not shown) is in a tubular shape having a predetermined length, wherein one end thereof is disposed on the lower portion of the housing 100 while the other end is present inside the container so as to transfer the content received in the container to the inside of the housing 100.

The discharge unit 300 may include an actuator 310, a stem 320, a chaplet 330, a gasket 340, a closure 350, a sub-stem 360 and a piston 370. However, the above components are not essential for implementing the discharge unit 300, instead, the discharge unit 300 may be provided with a larger or smaller number of components than the above-mentioned components.

The discharge unit 300 may be coupled on the upper portion of the housing 100, while some of the components included in the discharge unit 300 (for example, the actuator 310) may discharge the content received in the housing 100 to the outside while moving up and down by an external pressure.

The discharge unit 300 may be formed using a plastic material. For example, the plastic material used herein may include at least one among high-density polyethylene (HDPE), polyvinyl chloride (PVC), polypropylene (PP), polyethylene (PE), acrylonitrile butadiene styrene copolymer (ABS), polycarbonate-acrylonitrile butadiene styrene copolymer (PC-ABS) and ethylene-vinyl acetate copolymer (EVA), but is not particularly limited thereto.

Meanwhile, the actuator 310 may be connected to the stem 320 to discharge the content to the outside.

The actuator 310 may include a passage member 311, a nozzle member 312, a guard member 313 and an extension member 314. However, these components are not essential for implementing the actuator, instead, the actuator 310 may be provided with a larger or smaller number of components than the above-mentioned components.

The passage member 311 is connected to enclose at least a part of the upper portion of the stem 320, and may include a second passage 311a therein. Herein, the second passage 311a may be connected to a first passage 321 of the stem 320 described later. At this time, each of the first passage 321 and the second passage 311a may become a passage through which the content moves. Meanwhile, the second passage 311a may be formed in a longitudinal direction, that is, a length direction such that the content moves from a lower portion to an upper portion through the first passage 321.

Meanwhile, the nozzle member 312 is formed on an upper portion of the passage member 311, and may include a third passage 312a therein. Herein, the third passage 312a is connected to the second passage 311a to discharge the content to the outside. Specifically, the third passage 312a may be open at one side to communicate with the second passage 311a while being extended outward at the other side in order to discharge the content to the outside. Further, an outlet may be formed on the other side of the third passage 312a. Therefore, the content received in the second space 120 of the housing 100 may move from the lower portion to the upper portion through the first passage 321 of the stem 320 and the second passage 311a of the passage member 311, and may be discharged to the outside through the outlet of the third passage 312a of the nozzle member 312 connected to the second passage 311a.

Meanwhile, the guard member 313 encloses the passage member 311 along a periphery of the passage member 311, and may be extended toward the lower portion of the passage member 311. Specifically, the guard member 311 may enclose at least a part of the elastic member 400 when coupled to the housing 100. Therefore, when coupled to the housing 100, the guard member 313 may prevent external foreign materials from contacting the elastic member 400 so as to retain the elastic restoration force of the elastic member 400, but is not particularly limited thereto.

Further, the extension member 314 may be extended outward on an outer periphery of the guard member 313. Specifically, the extension member 314 may be extended in the opposite direction of the nozzle member 312. Therefore, the presence of the extension member 314 may enlarge an area in contact with the palm of a user, so as to easily apply a pressure to the actuator 310 by the user.

According to some embodiments of the present disclosure, a longitudinal cross-section of the upper portion of the actuator 310 may have an arched shape. In this case, the user may easily apply a pressure to the actuator 310.

Further, the stem 320 may be partially inserted into the housing 100 from the upper portion of the housing 100. Specifically, at least a part of the stem 320 is disposed in the first space 110, and the stem may have a cylindrical shape including the first passage 321 therein. More specifically, a lower portion of the stem 320 is disposed in the first space 110 of the housing 100 while an upper portion of the stem 320 may be provided to protrude upward on a top surface of the housing 100, however, the shape of the stem 320 is not particularly limited thereto.

Further, the upper portion of the stem 320 may be connected to the lower portion of the actuator 310. Specifically, an outer periphery of the upper portion of the stem 320 may be coupled to be in contact with an inner periphery of the passage member 311 of the actuator 310. Therefore, the second passage 311a of the passage member 311 may be connected to the first passage 321 of the stem 320. That is, the content in the second space 120 of the housing 100 may move to the second passage 311a of the passage member 311 through the first passage 321 of the stem 320, and then may be discharged to the outside through the third passage 312a of the nozzle member 312 connected to the second passage 311a.

Further, the elastic member 400 may be provided on the outer periphery of the stem 320. Specifically, the elastic member 400 may be provided on the outer periphery of the stem 320 to enclose at least a part of the outer periphery of the stem 320.

Meanwhile, the chaplet 330 is formed in a hollow cylindrical shape, and at least a part thereof may be disposed in the first space 110 of the housing 100. Specifically, at least a part of the chaplet 330 may be disposed in the first space 110 of the housing 100 to be in close contact with an inner wall of the housing 100. Further, the stem 320 may pass through the inside of the chaplet 330 to be inserted, while the elastic member 400 may be provided on the outer periphery of the stem 320. Specifically, the chaplet 330 may be formed with a length to be inserted into the upper portion and to reach a middle part of the lower portion of the housing 100.

Further, the chaplet 330 may include a seating member 331 protruding inward on the lower portion thereof. In this regard, the lower portion of the elastic member 400 may be seated on a top surface of the seating member 331. Therefore, when the actuator 310 and the stem 320 descend by an external pressure, the lower portion of the elastic member 400 does not move downward owing to the seating member 331 of the chaplet 330, whereas only the upper portion and middle portion of the elastic member 400 may move downward. Therefore, if compression is done while removing the external pressure, the elastic member 400 may be extended to arrange at least one component of the discharge unit 300 (for example, the actuator 310 and the stem 320) in a position before application of the external pressure by the elastic restoration force. Further, the seating member 331 may prevent the inserted stem from descending to more than a predetermined depth. Specifically, when the actuator 310 and the stem 320 descend to a predetermined depth by an external pressure, the guard member 313 is engaged in the seating member 331 of the chaplet 330 and thus may prevent the stem 320 from descending to more than the predetermined depth.

Meanwhile, the gasket 340 is formed in a ring shape, and may be coupled on an upper outer periphery of the chaplet 330 in order to allow packing between the chaplet 330 and the closure 350. Further, the gasket 340 may further be provided with a gasket coupler on the outside, thereby being coupled to the enclosure 350. The gasket coupler is formed to have a lower area larger than an upper area thereof and may mean a part in which a sill is formed between the upper portion and the lower portion.

Further, the closure 350 may be formed in a hollow cylindrical shape, wherein an upper portion is formed to enclose an outer periphery of the gasket 340 and an upper portion of the chaplet 330, while a lower portion may be formed to be spaced apart from the housing 100. Therefore, the container may be coupled in a space formed by the above spacing between the lower portion and the housing 100. However, a position at which the container is coupled is not particularly limited.

Meanwhile, the sub-stem 360 may be coupled on the lower portion of the stem 320 and may move up and down by an external pressure. Further, the sub-stem 360 may include a first seating groove 361 formed inside the bottom surface. According to some embodiments of the present disclosure, the sub-stem 360 is hollow inside and may be formed by a sub-stem flow path perforating in a longitudinal length of the sub-stem 360. Further, the sub-stem 360 may transfer the content of the housing 100 to the stem 320 through the sub-stem flow path while moving up and down by the external pressure.

Meanwhile, the piston 370 may be provided such that the inside of the piston 370 is in close contact with an outer periphery of the sub-stem 360 while the outside of the piston 370 is in close contact with an inner wall of the housing 100. Therefore, the piston 370 may separate the inside of the housing 100 into the first space 110 and the second space 120. Specifically, the first space 110 may be an upper space of the piston 370 inside the housing 100, while the second space 120 may be a lower space of the piston 370. Further, the piston 370 may prevent the content of the second space 120 from moving into the first space 110. Further, the piston 370 may change internal pressure of the housing 100 to move the content while moving up and down by the sub stem 360.

Further, in order to transfer the content received in the container connected to the transfer unit 200 to the inside of the housing 100 (for example, the second space 120) and then discharge the content transferred into the housing 100 to the outside through the discharge unit 300, a change in pressure inside the housing 100 is required. Specifically, a part of the discharge unit 300 descends by the external pressure to thus narrow the space inside the housing 100, which in turn increases internal pressure of the housing 100 to thus discharge the content received in the housing 100 to the outside. Further, when the descent part of the discharge unit 300 ascends to its original position, the internal pressure of the housing 100 decreases to thus move the content received in the container through a dip tube (not shown) of the transfer unit 200 into the housing 100. Therefore, it is important that a part of the discharge unit 300 is operated to smoothly move up and down inside the housing 100. According to some embodiments of the present disclosure, the pump dispenser may operate a part of the discharge unit 300 to smoothly move up and down by means of the elastic member 400.

The elastic member 400 may be provided such that at least a part thereof is disposed in the first space 110 while enclosing at least a part of the outer periphery of the stem 320. Specifically, the upper portion of the elastic member 400 is present on the upper portion of the stem 320 while the lower portion of the elastic member may be seated on the top surface of the seating member 331 of the chaplet 330. Therefore, when the step 320 descends by an external pressure, the upper and middle portions of the elastic member 400 may move downward along with the stem 320 whereas the lower portion of the elastic member 400 may not move downward owing to the seating member 331 of the chaplet 330.

Meanwhile, if a pressure is released after applied downward through the actuator 310 connected to the stem 320, the elastic member 400 may displace at least one component of the discharge unit 300 (for example, the actuator 310, stem 320, sub-stem 360 and piston 370) to the position before application of the pressure by elastic restoration force. Therefore, the elastic member 400 may have a configuration for smooth compression and elongation. A detailed description thereof will be provided later with reference to FIG. 3.

Like some embodiments illustrated in FIGS. 1 to 3, the pump dispenser may include an elastic member 400 made of a non-metal material having elastic restoration force instead of a metal spring, therefore, may be easily recycled or reused. Further, the pump dispenser may be provided with a guard member 313 of an actuator 310, wherein the elastic member 400 is disposed in a first space to which a content of the housing is not transferred. Therefore, it is possible to prevent external foreign materials and the content from being in contact with the elastic member 400, thereby retaining the elastic restoration force of the elastic member 400.

The description of the proposed embodiments is provided to enable those skilled in the art to use or implement the present disclosure. Various modifications to these embodiments will be apparent to those skilled in the art, and the generic principles defined herein may also be applied to other embodiments without departing from the scope of the present disclosure. Therefore, the present disclosure is not intended to be restricted to the embodiments proposed herein but is to be interpreted in the widest scope consistent with the principles and novel features presented herein.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. An elastic member made of a non-metal material, which is used for a pump dispenser, comprising:
an upper ring;
a lower ring; and
a plurality of links, which are laminated and connected in a zig-zag form between the upper ring and the lower ring so as to provide elastic restoration force for compression or elongation.

2. The elastic member according to claim 1, wherein two adjacent links among the plurality of links are connected at the ends thereof to be inclined to each other, wherein consecutive links are connected alternately at one side and other side in a width direction of the elastic member.

3. The elastic member according to claim 2, further comprising a first reinforcing unit provided on a portion at which the two adjacent links among the plurality of links are connected in order to reinforce the elastic restoration force while coupling the two adjacent links.

4. The elastic member according to claim 3, further comprising:
a second reinforcing unit that reinforces the elastic restoration force while coupling the upper ring and a first link connected to the upper ring among the plurality of links; and
a third reinforcing unit that reinforces the elastic restoration force while coupling the lower ring and a second link connected to the lower ring among the plurality of links.

5. The elastic member according to claim 1, wherein each of the upper ring, the lower ring and the plurality of links has a center hole through which at least a portion of a stem in the pump dispenser passes.

6. The elastic member according to claim 1, wherein the non-metal material is any one material among plastic, rubber and thermoplastic elastomer materials.
